(19) United States
(12) Patent Application Publication
(10) Pub. No.: US 2026/0009389 A1
(43) Pub. Date: Jan. 8, 2026

(54) Blower

(71) Applicant: YAMABIKO CORPORATION, Tokyo (JP)

(72) Inventors: Yuji NUMAKUNAI, Ohme-shi (JP); Ryuta ASANO, Ohme-shi (JP)

(21) Appl. No.: 19/257,187

(22) Filed: Jul. 1, 2025

(30) Foreign Application Priority Data
Jul. 8, 2024 (JP) 2024-109352

(51) Int. Cl. F04D 25/06; F04D 19/00; F04D 29/70

(52) U.S. Cl. CPC F04D 25/0673; F04D 19/002; F04D 29/703

(57) ABSTRACT

A blower adapted to be used by mounting a battery is provided and includes a body portion including: a jet port provided at a front side of the body portion; an airflow generation unit configured, by being supplied with electric power from the battery, to generate an airflow in an interior space of the body portion from a rear of the body portion toward the jet port; and a partition wall disposed to divide the interior space into a first space and a second space, wherein: the first space is configured to receive the battery, and the second space is positioned outside of the first space, and is configured to allow the airflow to pass therethrough.

### CROSS REFERENCE TO RELATED APPLICATIONS

The present application claims priority under 35 U.S.C. §119 to Japanese Patent Application No. 2024-109352, filed July 8, 2024. the contents of which are incorporated herein by reference in their entirety.

### BACKGROUND

### TECHNICAL FIELD

The present invention relates to a blower.

### RELATED ART

JP2014148950(A) discloses a relatively high output electric motor tool. In this electric motor tool, a battery pack for low-power use is configured to be usable as an electric power source, thereby enhancing the convenience thereof and ease of handling.

The electric motor tool according to JP2014148950(A) is an electric blower including a tubular nozzle for blowing air at the front side of the housing, an air blowing fan that sends air to the nozzle by rotation, and an electric motor that drives this air blowing fan by rotation in the housing. The electric blower includes a plurality of mounting portions where separate rechargeable battery packs can each be attached to the housing, and configured so that the electric motor is driven by the electric power of the plurality of battery packs attached to these mounting portions.

However, the conventional technology disclosed in JP2014148950(A) still has room for improvement.

### SUMMARY

In view of the above circumstances, the present disclosure provides a blower with improved operability at higher output.

According to one aspect of the present disclosure, a blower is provided which is adapted to be used by mounting a battery, comprising a body portion including: a jet port provided at a front side of the body portion; an airflow generation unit configured, by being supplied with electric power from the battery, to generate an airflow in an interior space of the body portion from a rear of the body portion toward the jet port; and a partition wall disposed to divide the interior space into a first space and a second space, wherein: the first space is configured to receive the battery, and the second space is positioned outside of the first space, and is configured to allow the airflow to pass therethrough.

With this configuration, it is possible to improve operability at high output by increasing the cooling efficiency of the battery.

### BRIEF DESCRIPTION OF THE DRAWINGS

FIG. 1 is a perspective view of the blower from the top.

FIG. 2 is a perspective view of the blower from the below.

FIG. 3 is a left side view shown in the plane defined by front-to-rear and up-and-down along the axis.

FIG. 4 is a perspective view of a blower with a filter in the air intake port from below.

FIG. 5 is a left side view of the blower shown in FIG. 4, shown in the plane defined by front-to-rear and up-and-down along the axis.

FIG. 6 is a left side view showing the relationship between the communication hole of the partition wall and the through hole in the battery, which are connected through the battery mounting portion.

FIG. 7 is a left side view showing the relationship between the communication hole of the partition wall and the through hole in the battery, which are connected through the battery mounting portion.

FIG. 8 is a left side view showing the relationship between the communication hole of the partition wall and the through hole in the battery, which are in direct communication with each other.

FIG. 9 is a left side view showing the relationship between the front portion of the first space and the rear-end surface of the coupling portion of the airflow generation unit.

FIG. 10 is a perspective view showing the air intake port that opens in the wall portion and the circumferential wall portion of the body portion.

### DETAILED DESCRIPTION

Hereinafter, an example of the embodiment of the present disclosure will be described with reference to the drawings. Various features described in the embodiment below can be combined with each other.

### Overall Configuration

In Chapter 1, a description will be given of one embodiment of Blower 1. The blower 1 is an electric power device that blows air and is used, for example, to blow away fallen leaves, debris, pebbles, water droplets, and other objects (hereinafter simply referred to as an "object"). The blower 1 is a blower to be used by mounting a battery 7 attached, for example, a centrifugal blower with a centrifugal fan (not shown) or an axial blower 10 with an axial flow fan. The following is an example of an axial flow blower 10 (blower 1).

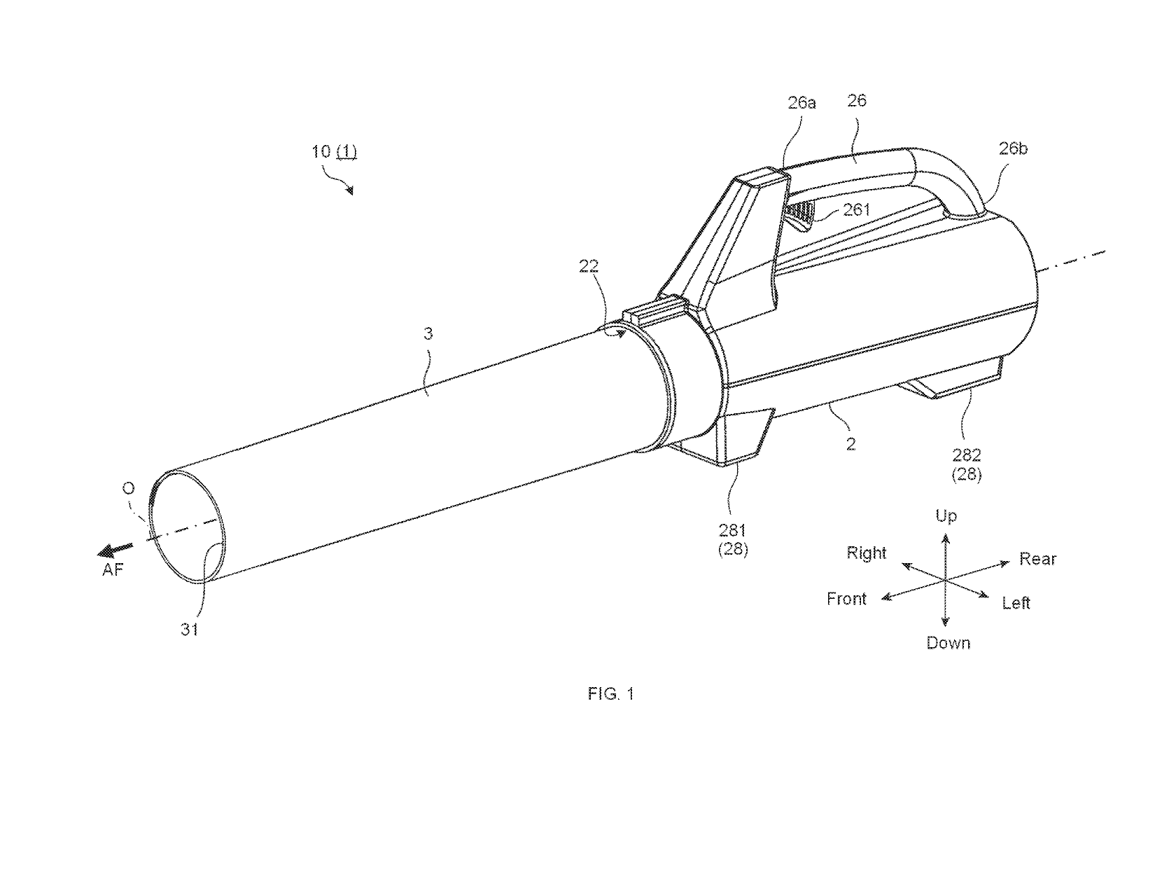

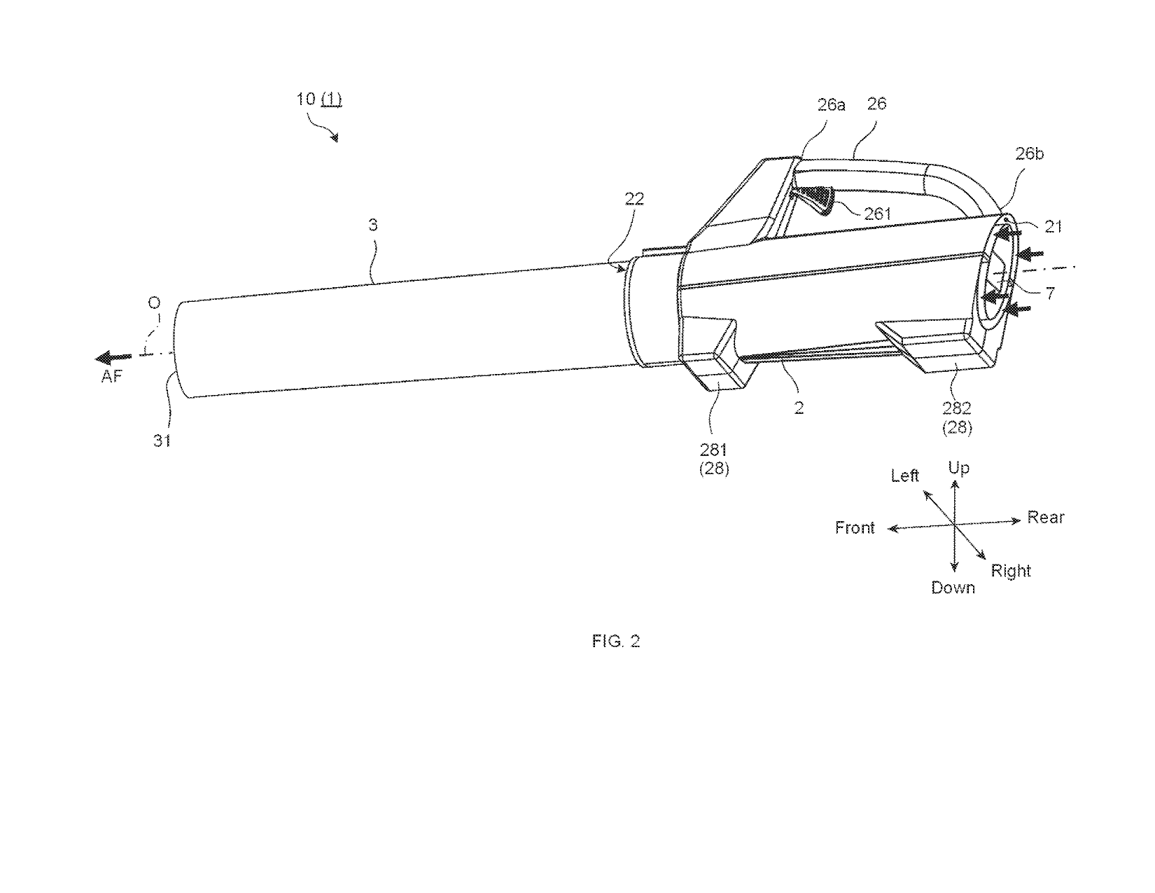

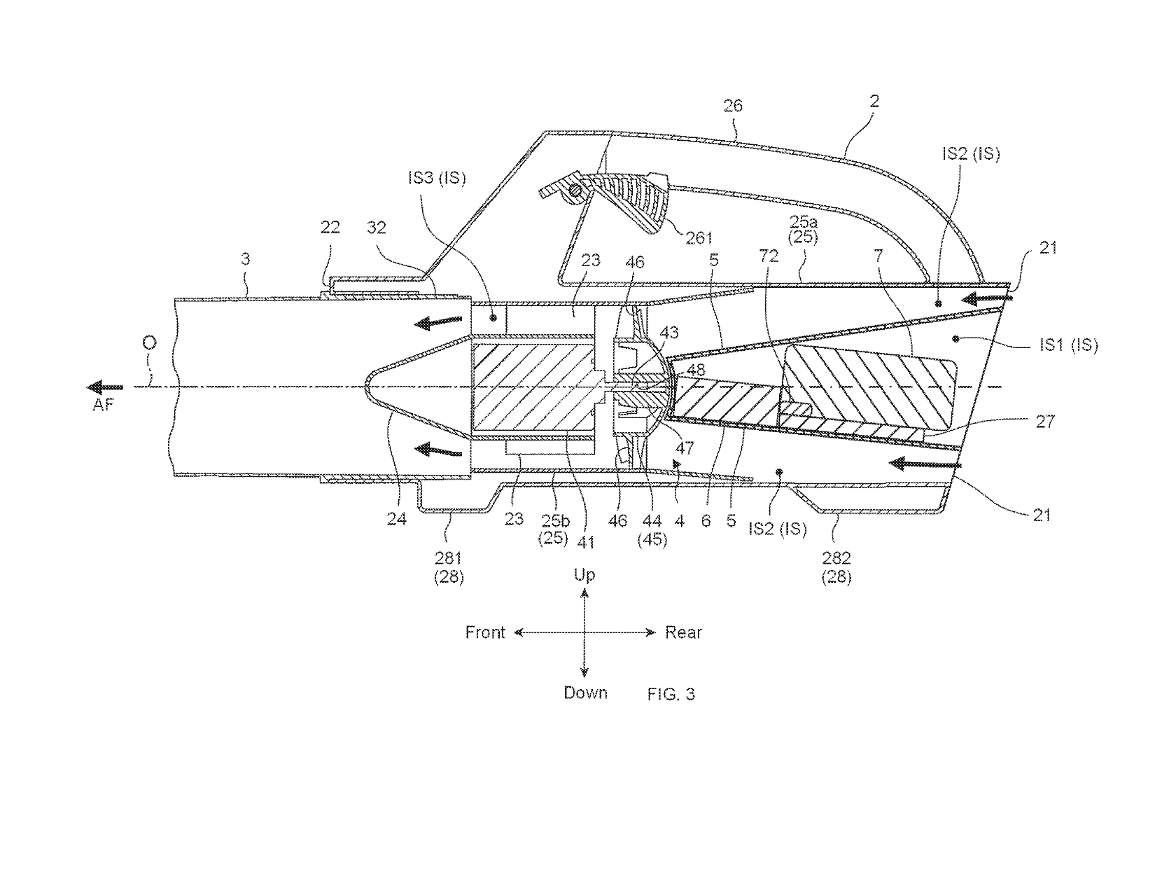

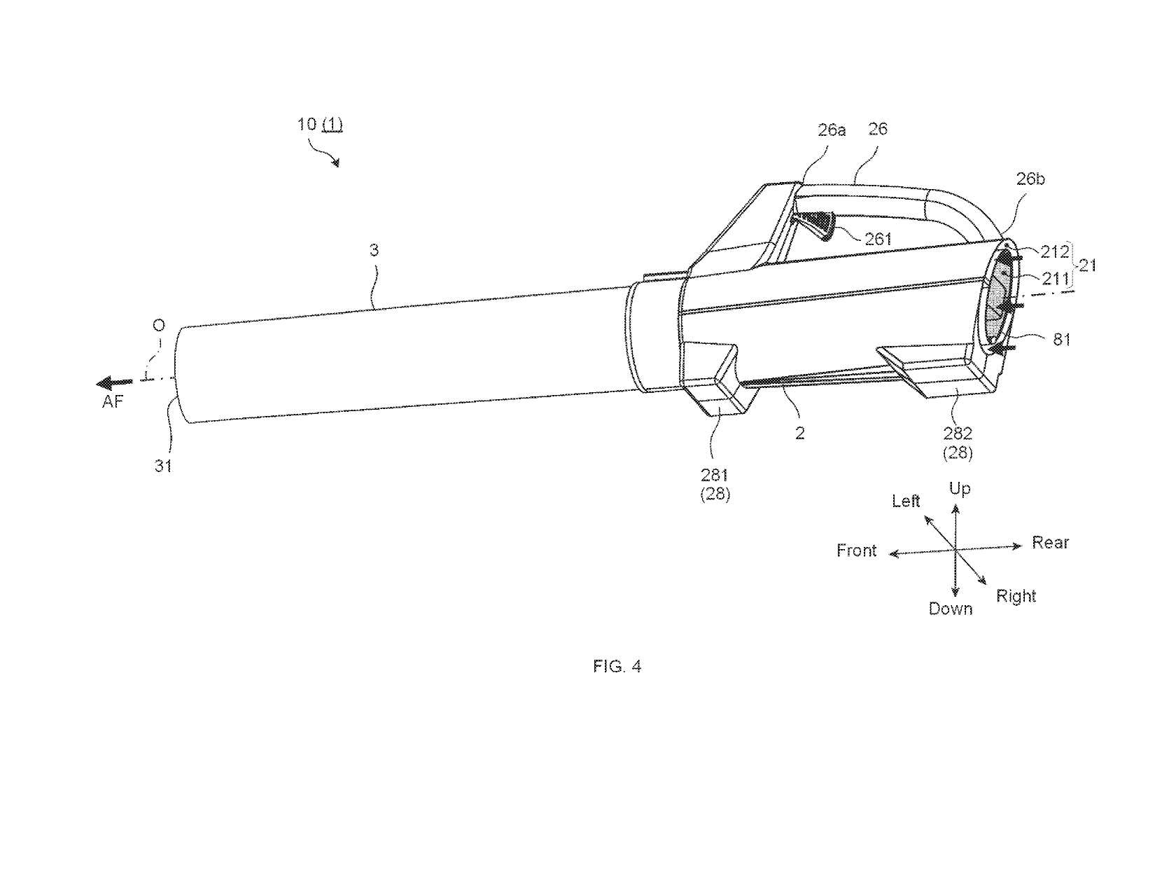

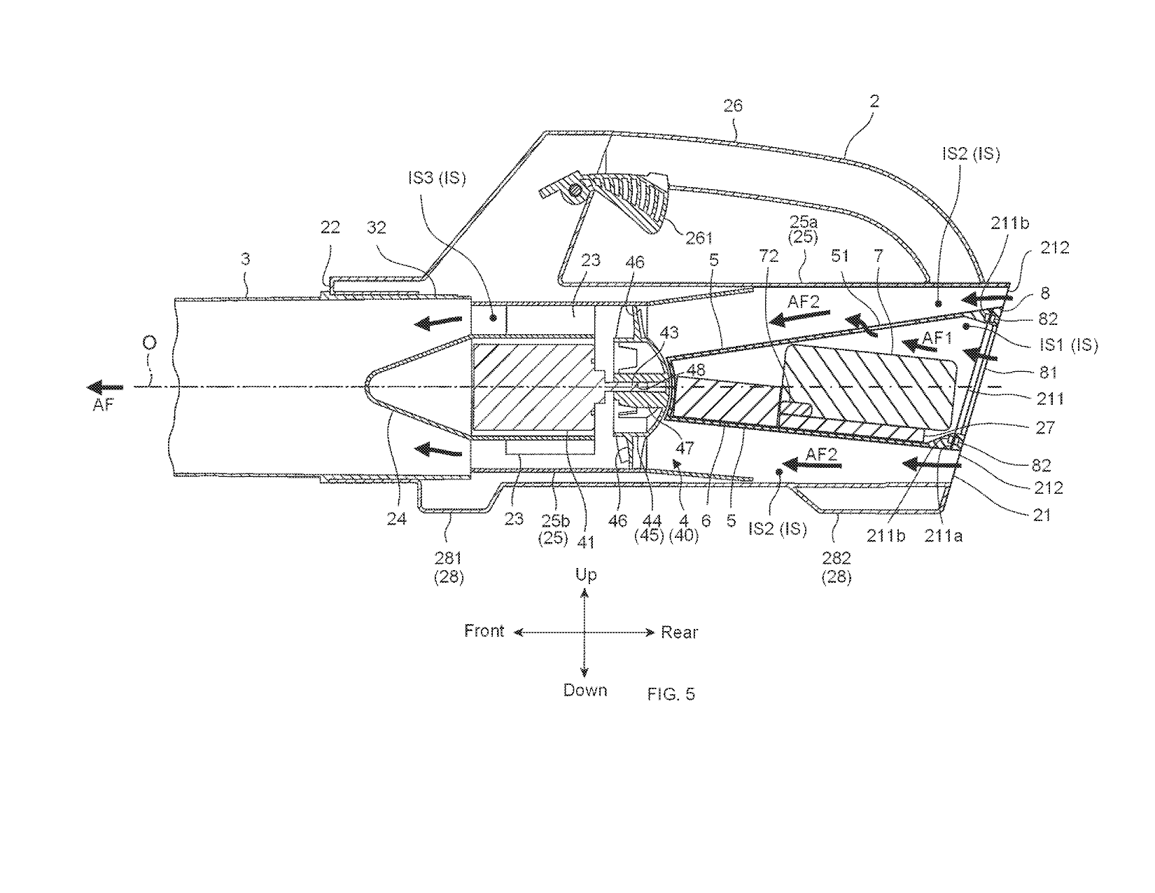

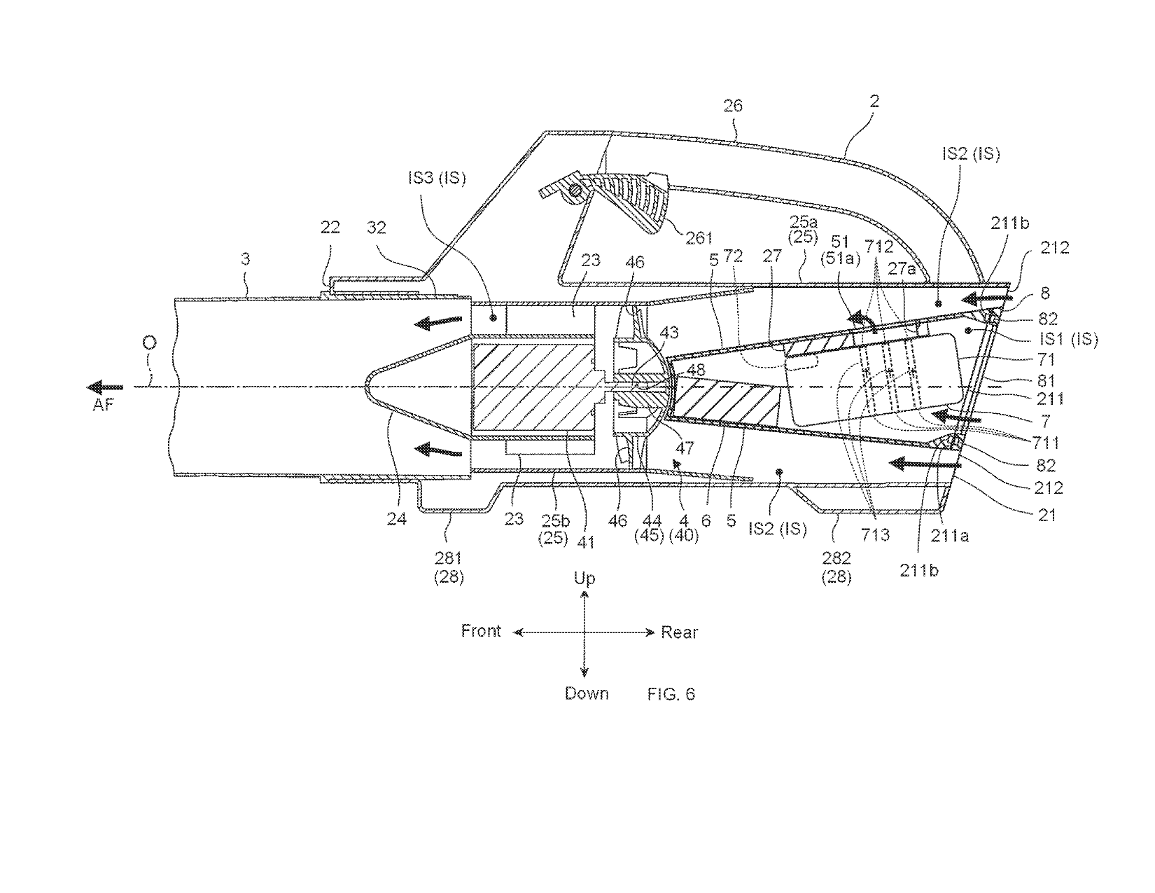

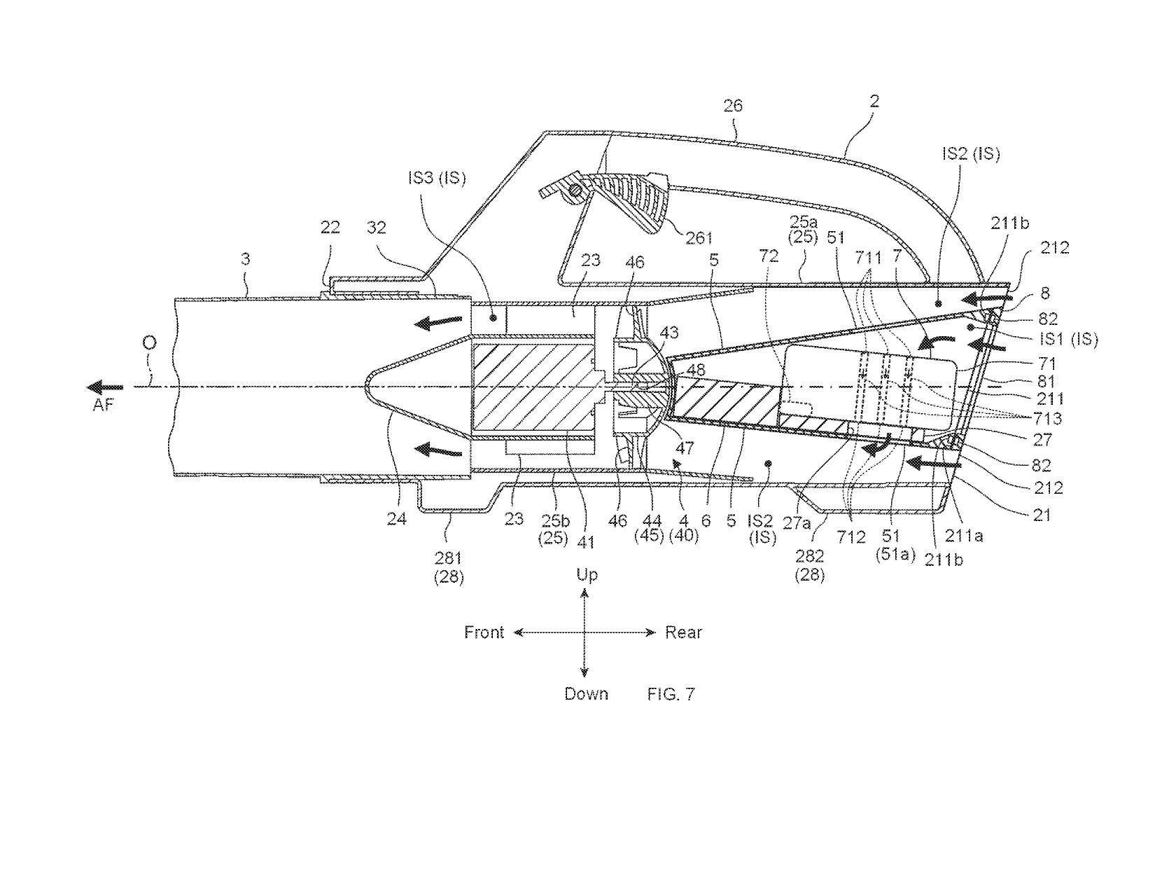

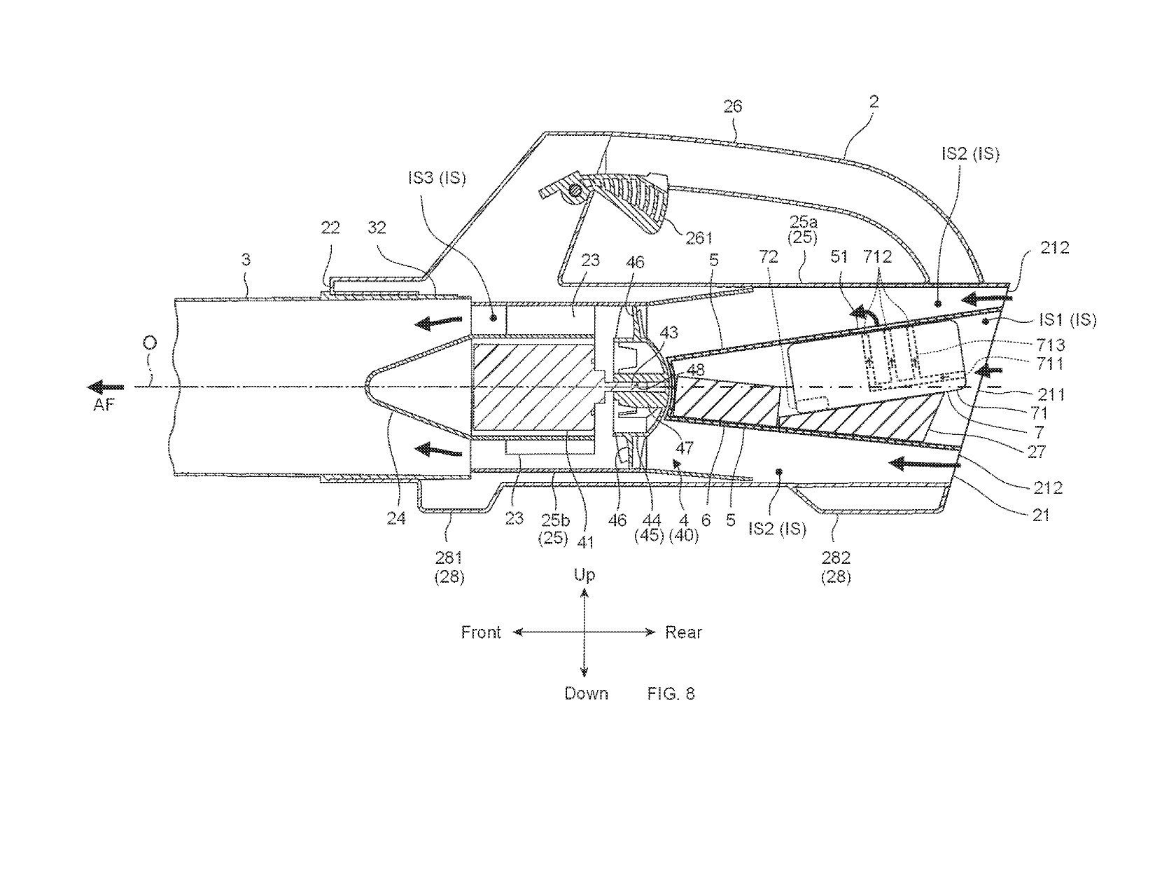

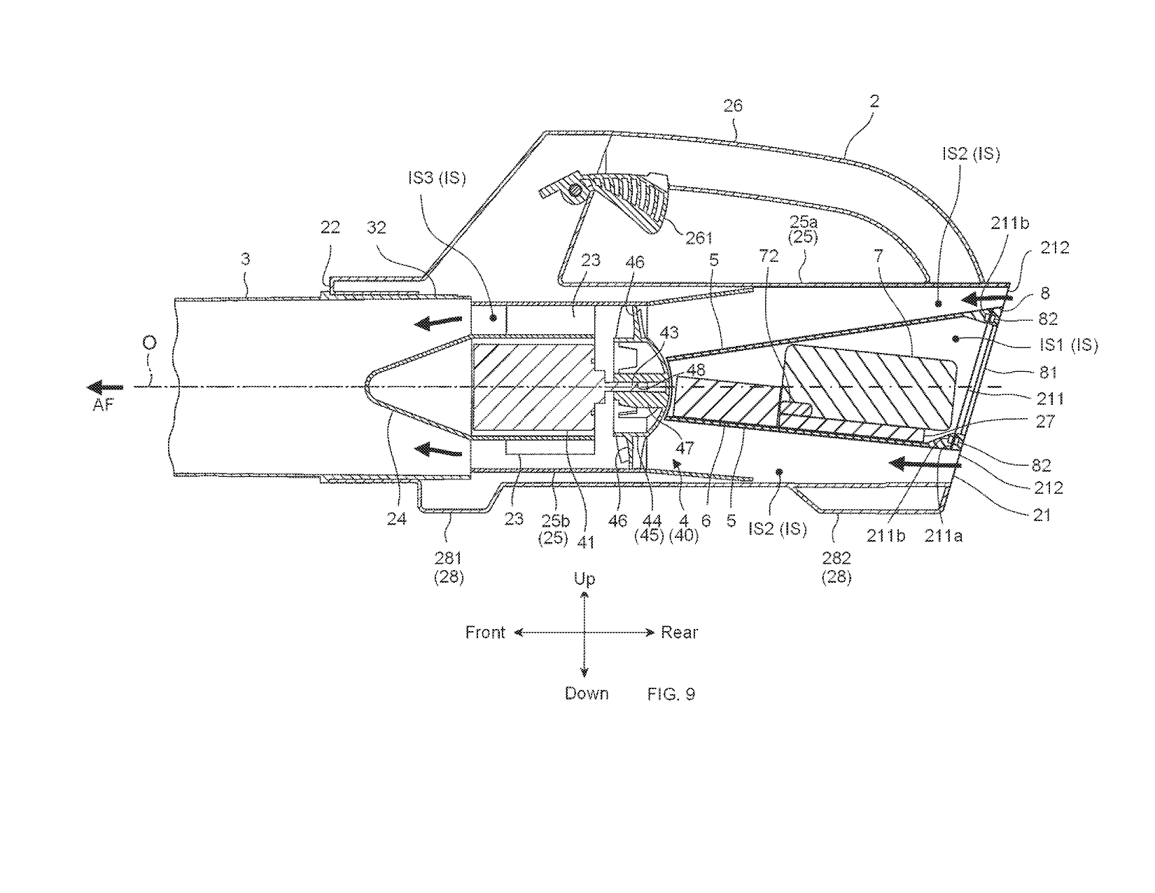

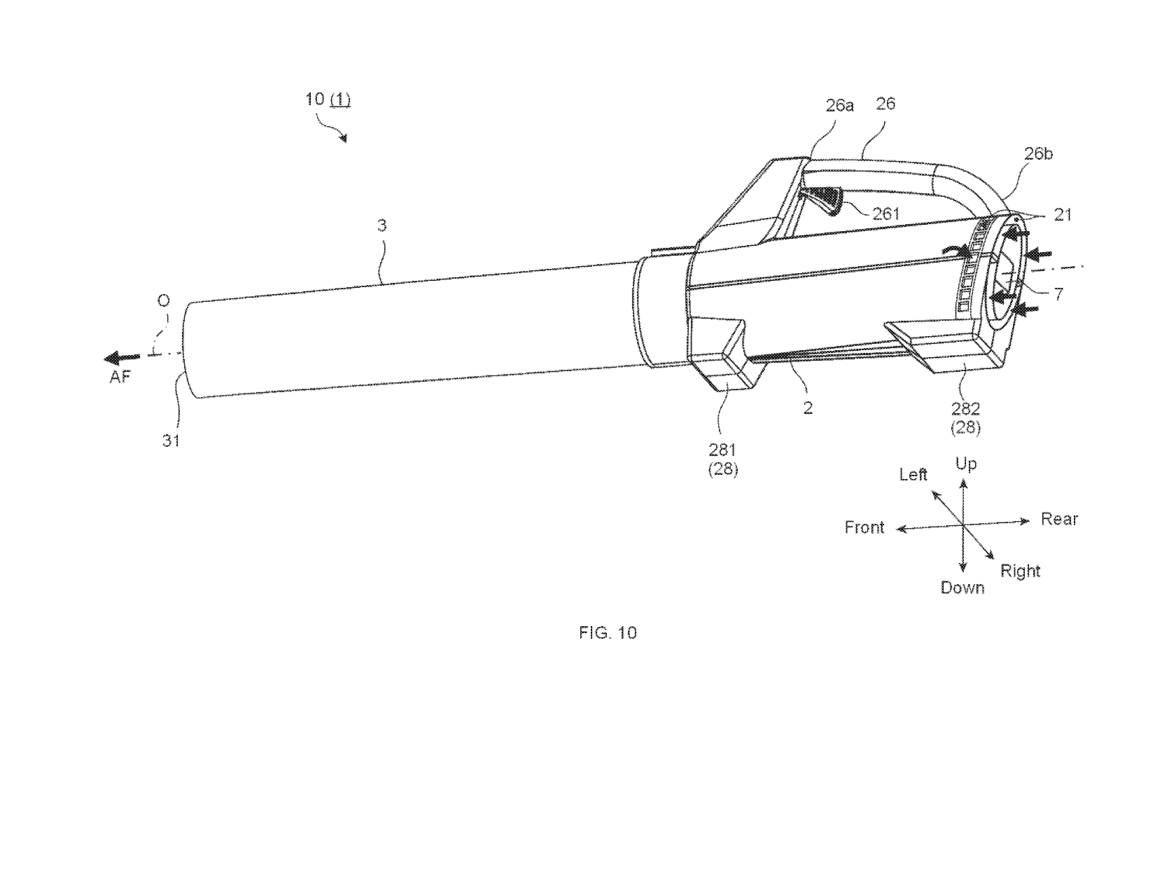

FIG. 1 is a perspective view of the blower from the top. FIG. 2 is a perspective view of the blower from the below. FIG. 3 is a left side view shown in the plane defined by front-to-rear and up-down along the axis. FIG. 4 is a perspective view of a blower with a filter in the air intake port from the below. FIG. 5 is a left side view of the blower shown in FIG. 4, shown in the plane defined by front-to-rear and up-and-down along the axis. FIG. 6 is a left side view showing the relationship between the communication hole of the partition wall and the through hole in the battery, which are connected through the battery mounting portion. FIG. 7 is a left side view of the relationship between the communication hole of the partition wall and the through hole in the battery, which are connected through the battery mounting portion. FIG. 8 is a left side view showing the relationship between the communication hole of the partition wall and the through hole in the battery, which are in direct communication with each other. FIG. 9 is a left side view showing the relationship between the front portion of the first space and the rear-end surface of the coupling portion of the airflow generation unit. FIG. 10 is a perspective view showing the air intake port that opens in the wall portion and the circumferential wall portion of the body portion. In the following description, the axial direction of the axial blower 10 and each member of the axial blower 10 is defined based on the "up and down", "right and left" and "front and rear" shown in the figure. In detail, the side to which the blower pipe 3 is attached when looking at the axial flow blower 10 in the figure is defined as the "front/front side," "forward" or "front- end/front-end side," and the side opposite the side to which the blower pipe 3 is attached in the figure is defined as the "rear/rear side," "backward" or "rear-end/rear-end side." The right side is defined as "right" or "right side" and the left side as "left" or "left side" when the axial flow blower 10 is viewed from above and behind in the figure.

As shown in FIG. 1 and FIG. 2, the axial flow blower 10, which corresponds to blower 1 in one embodiment, includes a body portion 2 in which an internal space IS is formed, extending from an air intake port 21 to a jet port 22 and a blower pipe 3 that is inserted and fitted into the jet port 22. In the axial flow blower 10, as shown in FIG. 3, the driving force of the motor 41 provided by the airflow generation unit 4 causes the fan 44 connected to the motor 41 to rotate in the internal space IS, generating a high-speed airflow AF from the air intake port 21 to the discharge port 31 of the blower pipe 3. The airflow AF is then discharged from the discharge port 31 to the outside. The operator can blow the object away by holding the axial flow blower 10 and blowing the airflow AF discharged from the discharge port 31 onto the ground. The details of these configurations are described below. (body portion 2)

### body portion 2

The body portion 2 is a resin body cylinder or box that extends in the front-rear direction and includes an opening at the front-end at the jet port 22. An air intake port 21 is formed at the rear-end of the body portion 2 so as to allow external air from outside the body portion 2 to be taken therein. That is, the body portion 2 includes an air intake port 21 and a jet port 22. The body portion 2 contains the mechanical and electrical equipment for operating the axial flow blower 10. This mechanical and electrical device include a battery mounting portion 27, an airflow generation unit 4, a partition wall 5, a control unit 6, and a battery 7. In addition, the body portion 2 includes a handle portion 26 and legs 28 on the outer portion.

As shown in , the body portion 2 includes an internal space IS therein that leads from the air intake port 21 to the jet port 22. The internal space IS functions as an airflow path that directs the external air taken in through the air intake port 21 to the jet port 22. The interior space IS includes a first space IS1, a second space IS2, and a third space IS3.

The first space IS1 and the second space IS2 are positioned within the center portion to the rear portion of the body portion 2. The first space IS1 and the second space IS2 are formed by dividing the interior space IS, which is defined by the rear outer cylinder 25a, with the partition wall 5. That is, the partition wall 5 is disposed to divide the interior space IS into a first space IS1 and a second space IS2.

Specifically, the following describes the configuration. The partition wall 5 is a resin cylindrical member that extends in the front-rear direction and is positioned within the center portion to the rear portion of the body portion 2. The partition wall 5 is tapered so that the bore (inside diameter) expands from the front side to the rear side. The surface of the rear-end side of the partition wall 5 is open in substantially a circular shape, and the front-end side is closed in a cylindrical shape portion. With this configuration, the inner conical space formed by the partition wall 5 constitutes the first space IS1. A battery mounting portion 27 where a battery 7 can be attached or detached and a control unit 6 are disposed inside the partition wall 5, and the battery 7 is attached to the battery mounting portion 27. In other words, the first space IS1 is configured to dispose the battery mounting portion 27, the control unit 6 and the battery 7.

Further, the rear outer cylindrical portion 25a is a resin cylindrical member that extends straight in the front-rear direction and is positioned within the center portion to the rear portion of the body cylinder portion 2. The rear outer cylindrical portion 25a has a larger diameter than the cylindrical outer diameter formed by the partition wall 5 and is positioned outside of the partition wall 5. With this configuration, a second space IS2 is formed between the cylindrical inner wall of the rear outer cylindrical portion 25a and the cylindrical outer wall of the partition wall 5, which is positioned inside that inner wall.

The rear side outer cylinder portion 25a and the rear-end of the partition wall portion 5 form an air intake port 21 so that outside air is taken in at the rear of the body portion 2. That is, the air intake port 21 is configured to open in the rear wall of the body portion 2 and direct external air into the second space IS2 of the body portion 2. The second space IS2 is positioned outside of the first space IS1 and is configured to allow the airflow AF to pass therethrough. With this configuration, an airflow AF is generated in the second space IS2, which is outside of the first space IS1 where the battery 7 is disposed. Thus, the partition wall 5 that separates the first space IS1 from the second space IS2 is cooled by the air flow AF, making it possible to cool the battery 7 through the partition wall 5. As a result, the cooling efficiency of the battery 7 can be increased to improve operability at high output. The second space IS2 may surround the entire circumference of the first space IS1 or a portion of the entire circumference of the first space IS1. In the latter case, the second space IS2 can be a space positioned in an upward, downward, rightward, leftward, or a combination of these directions of the first space IS1. In particular, the second space IS2 preferably forms a space surrounding the entire circumference of the first space IS1. With this configuration, the partition wall 5 is disposed to demarcate the periphery of the first space IS1, and external air is led into the second space IS2, which allows efficient cooling of the battery 7 and further improves the operability of the battery at high output.

The third space IS3 is positioned within the center portion to the front portion of the body portion 2 and is formed by the front outer cylinder portion 25b. The front outer cylinder portion 25b is a resin cylindrical member that extends in the front-rear direction and is positioned within the center portion to the front portion of the body portion 2. The front portion of the front outer cylinder portion 25b extends straight in the front-rear direction (the bore (inside diameter) is formed constant in the front-rear direction) and is formed to have a slightly smaller diameter than the rear-end (base) of the blower pipe 3. The rear portion of the front outer cylinder portion 25b is tapered so that the bore (inner diameter) expands (widens) from the front side to the rear side, and the rear-end of the front side outer cylindrical portion 25b is slightly larger in diameter than the rear-end (base) of the blower pipe 3.

The front edge (opening in the front-end face) of the front outer cylinder portion 25b includes a jet port 22, and the jet port 22 is configured so that the fitting portion 32 of the blower pipe 3 is insertable and engageable. That is, the jet port 22 is provided at the front side of the body portion 2. The outer surface of the rear edge (opening in the rear-end surface) of the front outer cylinder portion 25b is in contact with the inner surface of the rear outer cylinder 25a. This allows the second space IS2 and the third space IS3 to be connected. The airflow generation unit 4 is disposed inside the front outer cylinder portion 25b. That is, the airflow generation unit 4 is disposed in the third space IS3. The airflow generation unit 4 disposed in the third space IS3 generates an airflow AF in the interior space IS of the body portion 2 from the rear of the body portion 2 to the jet port 22. Details of the airflow generation unit 4 are described below. (Blower pipe 3)

The blower pipe 3 is a resin cylindrical member (straight pipe) that extends in the front- rear direction. The blower pipe 3 includes, at the rear portion, the fitting portion 32 that can be removably mounted to the body portion 2. The fitting portion 32 is configured to be insertable and engageable with the jet port 22 of the body portion 2. The front portion of the blower pipe 3 protrudes forward from the jet port 22 of the body portion 2. The opening (tip opening) at the front side of the blower pipe 3 constitutes the discharge port 31. The blower pipe 3 may or may not be flexible.

### Motor cover 24 and Flow-straightening plate 23

The motor cover 24 is a resin plate container disposed in the third space IS3. The motor cover 24 is a cylindrical member having one closed end, and is disposed in the centerportion of the third space IS3 such that the longitudinal direction thereof aligns with the axis O. The rear-end surface of the motor cover 24 is open in a circular shape, and the front-end portion is closed in a conical shape.

The front part (conical shape portion) of the motor cover 24 protrudes so that it enters the interior of the blower pipe 3 when the blower pipe 3 is inserted and fitted into the body portion 2. The motor cover 24 is supported in the center of the front outer cylinder portion 25b by a plurality of flow-straightening plates 23, as shown in FIG. 3.

The flow-straightening plate 23 is interposed between the inner surface of the front outer cylinder portion 25b and the outer surface of the motor cover 24. The flow-straightening plate 23 is a rectangular plate-shaped resin member that extends in the front-rear direction so that the longitudinal direction is the front-rear direction. The inner end portion of the flow- straightening plate 23 is connected to the outer surface of the motor cover 24. Further, the outer end portion of the flow-straightening plate 23 is connected to the inner surface of the front portion of the front outer cylinder portion 25b. In other words, the flow-straightening plate 23 is a support member interposed between the inner surface of the front outer cylinder portion 25b and the outer surface of the motor cover 24. That is, the flow-straightening plate 23 is configured to support the motor cover 24 in the third space IS3.

The flow-straightening plate 23 rectifies the airflow AF (more specifically, the airflow AF delivered by the fan 44 downstream of the fan 44, described below) in the third space IS3. This flow-straightening plate 23 is also called a static blade. In one embodiment, a plurality (five in the illustrated example) of flow-straightening plates 23 are disposed at equal intervals in the circumferential direction of the front outer cylinder portion 25b.

The motor cover 24, each of flow-straightening plates 23, and the front outer cylinder portion 25b in one embodiment are integrally molded as a single component. However, the motor cover 24, each of flow-straightening plates 23, and the front outer cylinder portion 25b may be formed by assembling multiple parts that are formed separately.

### airflow generation unit 4

As shown in FIG. 3, the airflow generation unit 4 in the axial flow blower 10 is an axial flow fan 40. That is, the airflow generation unit 4 is configured to generate airflow AF by an axial flow fan 40. The axial flow fan 40 includes a motor 41 and a fan 44. The airflow generation unit 4 is disposed inside the third space IS3. External air taken in through the air intake port 21 disposed in the rear of the body portion 2 is directed to the airflow generation unit 4 through the second space IS2. That is, the airflow generation unit 4 is disposed forward of the partition wall 5 that forms the second space IS2. With this configuration, in the blower 1 including an axial flow fan 40, the battery 7 can be efficiently cooled, thereby improving operability at high output. In addition, designing the body portion 2 with a smaller circumferential dimension contributes to the downsizing of the blower 1.

The motor 41 is an electric motor and is housed in motor cover 24. That is, the motor 41 is disposed in the center portion of the third space IS3. The motor 41 includes a rotary shaft 43, and the rotary shaft 43 is positioned along the axis O. In the motor 41, the rotary shaft 43 is configured to rotate about axis O when electric current is supplied to the coil. The motor 41 is fixed within the motor cover 24. With the motor 41 fixed within the motor cover 24, the rotary shaft 43 protrudes backward from the rear-end surface of the motor cover 24.

The fan 44 is disposed behind the motor cover 24 and in the center portion of the third space IS3. The fan 44 includes a coupling portion 45 and a plurality of blade portions 46. The coupling portion 45 is a short cylindrical member and has the same diameter as motor cover 24. The rear-end surface of the coupling portion 45 is closed with a spherical surface (in other words, domed), and the front-end surface of the coupling portion 45 has a circular opening. A boss 47 is formed at the center portion of the coupling portion 45, and an insertion hole 48 for receiving the rotary shaft 43 of the motor 41 is formed in the boss 47. Then, by fitting the rotary shaft 43 of the motor 41 into the insertion hole 48 of the coupling portion 45, the coupling portion 45 is fixed to the rotary shaft 43 of the motor 41.

Further, the coupling portion 45 rotates relative to the motor cover 24, and forms a part of the motor cover 24 as a rear case thereof.

In one embodiment of the axial flow blower 10, a plurality of blade portions 46 are disposed (protruding) on the outer circumference of the coupling portion 45. In one embodiment, a plurality of blade portions 46 (12 in the illustrated example) are disposed at equal intervals in the circumferential direction of the coupling portion 45. When the motor 41 is driven and the rotary shaft 43 and fan 44 are rotated around the axis 0, each of the blade portions 46 generates an airflow from the rear (upstream side) to the front (downstream side) in the third space IS3. That is, in the axial flow blower 10, when the axial flow fan 40 rotates in the third space IS3 by the driving force of the motor 41, a high-speed airflow AF is generated from the upstream air intake port 21 to the downstream jet port 22 and discharge port 31. That is, the axial flow fan 40, which is an example of the airflow generation unit 4, is configured, by being supplied with electric power from the battery 7, to generate an airflow AF in the internal space IS of the body portion 2 from the rear of the body portion 2 toward the jet port 22. The blade portions 46 of the 40 axial-flow fan are also referred to as the rotating blades.

In one embodiment, the motor 41 (rotary shaft 43 of the motor) and the fan 44 are arranged with the rotating central axis along the axial direction O, facing forward and backward. The central axes of the motor 41 (rotary shaft 43) and fan 44 are coincident with the central axes of the blower pipe 3, outer rotary portion 25, and motor cover 24, and the internal space IS extends generally straight along the axis O.

### Handle 26

As shown in FIG. 1, a handle 26 is provided on the upper portion of the body portion 2. The handle 26 is a cylindrical member extending in the front-rear direction and is the part that is grasped by the operator. The front-end portion 26a and rear-end portion 26b of handle 26 are connected to the upper front portion and upper rear portion of the body portion 2. At the front of the handle 26 is a throttle lever 261 is provided as an operation means for increasing or decreasing the amount of airflow AF while the operator grips the handle. The throttle lever 261 is configured to press the head of a drive switch (not shown) provided inside the body portion 2. The drive switch controls the airflow generation unit 4 according to the depression amount of the head thereof, thereby increasing or decreasing the amount of air blown by the axial blower 10.

### Leg 28

As shown in FIG. 2, the leg 28 can maintain the axial flow blower 10 in a horizontal state when it is placed on the ground or a placement platform by contacting the ground or a placement platform. Further, when the axial flow blower 10 is dropped and the leg 28 hit the ground first, damage to the axial flow blower 10 can be reduced. Specifically, the leg 28 includes a front leg 281 disposed below a front side of body portion 2, and a rear leg 282 disposed below a rear side of body portion 2. The front leg 281 and rear leg 282 are configured to maintain the axial flow blower 10 in a horizontal state by coming into contact with the ground or a placement platform.

### Battery mounting portion 27

As shown in FIG. 3, the battery mounting portion 27 is provided inside the lower portion of the first space IS1 along the inner wall of the partition wall 5. In addition, the battery mounting portion 27 includes a metal connection terminal (not shown in the figure) and the connection terminal is electrically connected to the motor 41 and the control unit 6. When the connection terminal 72 of battery 7 is connected to the connection terminal of battery mounting portion 27, electric power is supplied from battery 7 to motor controller 41 and control unit 6.

### Control Unit 6

As shown in FIG. 3, the control unit 6 has a box shape and is fixed to the inner wall of the partition wall 5. The control unit 6 is electrically connected to the motor 41 and battery 7 by wiring and connectors, etc., and controls the power supply from the battery 7 to the motor 41. In other words, control unit 6 is configured to electrically control the rotation of the motor 41. The control unit 6 may include a heat sink to dissipate the heat generated by the control unit 6. With this configuration, the control unit 6 can be efficiently cooled by providing a heat sink, which improves operability at high output.

### Battery 7As shown in FIG. 3 , the battery 7 is a known battery, and is configured by housing a secondary battery, such as a lithium-ion secondary battery, in a rectangular case that extends in the front-rear direction. The size of the battery 7 is formed so as to fit within the first space IS1. The battery 7 provides sufficiently high output and charge capacity suitable for work.

When attaching the battery 7 to the battery mounting portion 27, the battery 7 is fitted into the battery mounting portion 27 by sliding the battery 7 into the battery mounting portion 27 from the rear toward the front. When the battery 7 is moved to the position where the battery 7 is supported by the battery mounting portion 27, the engagement portion of the battery 7 engages the battery mounting portion 27 and the battery 7 is fixed to the battery mounting portion 27.

The battery 7 mounted in the battery mounting portion 27 is disposed in an inclined orientation such that the rear side thereof is positioned lower than the front side thereof. The battery 7 includes a connection terminal 72, and when the battery 7 is fixed to the battery mounting portion 27, the connection terminal 72 of the battery 7 and the connection terminal of the battery mounting portion 27 (not shown) are electrically connected. That is, the battery 7 includes a connection terminal 72. Then, by connecting the connection terminal 72 of battery 7 to the connection terminal of battery mounting portion 27, electric power is supplied from battery 7 to motor 41 of airflow generation unit 4 and to control unit 6. That is, the battery mounting portion 27 is electrically connected to the airflow generation unit 4.

When the battery 7 is removed from the battery mounting portion 27, pulling up a connecting lever (not shown) of the battery 7 releases the engagement between the battery mounting portion 27 and the engaging portion, allowing the battery 7 to slide backward with respect to the battery mounting portion 27. That is, the battery mounting portion 27 is configured to allow the battery 7 to be removable.

### Configuration of the Internal Space IS and Components Disposed in the Internal Space IS

In this section, the configuration of the internal space IS of the axial flow blower 10 according to one embodiment, and the configuration of the components disposed within the internal space IS, will be described in detail with reference to FIGS. 4 to 10.

As mentioned above, the internal space IS includes a first space IS1 and a second space IS2. As shown in FIG. 5, the partition wall portion 5 that divides the first space IS1 from the second space IS2 preferably includes a communication hole 51. The communication hole

51 is configured to connect the first space IS1 to the second space IS2. One or more of the communication holes 51 may be provided at any location in the partition wall portion 5. Specifically, the communication hole 51 is disposed above the first space IS1 in a predetermined shape. The predetermined shape is, for example, a circle, ellipse, polygon, or the like. In other words, the communication hole 51 is configured to be positioned above the battery 7 when the blower 1 is in use. In this case, the state of use is as follows: the handle 26 is grasped so that the handle 26 is positioned above the axis 0, the blower 1 is used so that the blower pipe 3 faces the ground, and so on. The battery 7 and battery mounting portion 27 are disposed below the partition wall 5, and the battery 7 is attached to the battery mounting portion 27. Then, the battery 7 mounted in the battery mounting portion 27 is disposed at an angle so that the rear of the battery 7 is positioned lower than the front thereof. Since the connection terminal 72 of the battery 7 is positioned at the front side of the lower surface of the battery 7, the connection terminal 72 is positioned higher than the rear side of the lower surface of the battery 7. In other words, the battery mounting portion 27 is configured to be positioned opposite the communication hole 51 with respect to the battery 7 and is connected to the connection terminal 72 when the battery 7 is attached to the battery mounting portion 27. With this configuration, the first space IS1 and the second space IS2 are in communication via the communication hole 51, thereby allowing the airflow AF generated by the airflow generating unit 4 to further enhance the cooling efficiency of the battery 7. As a result, the operability can be further improved at high output. Moreover, with this configuration, since the communication hole 51 is positioned above the battery 7 in the state of use of the blower 1, heat generated by the heat generation of the battery 7 flows upward from below toward the communication hole 51 by the upward airflow. Further, the airflow AF allows the heat generated by the battery 7 to be directed to the communication hole 51 without accumulating in the first space IS1. Therefore,the blower 1 in such a configuration can provide excellent operability at high output. Further, when the blower 1 is not in use (i.e., when placed on a horizontal surface), the lower side of the partition wall 5 is inclined downward as moving from the front side to the rear side. With this configuration, water droplets on the battery 7 can be guided downward to the rear side of the battery 7 by the weight of the water droplets themselves. This prevents short circuits and corrosion of the battery 7 and battery mounting portion 27 due to water droplets.

As shown in FIG. 4 and FIG. 5, the air intake port 21 may have a first air intake port 211 and a second air intake port 212. In this case, the first air intake port 211 is configured to be connected to the first space IS1, and the second air intake port 212 is configured to be connected to the second space IS2. External air taken in through the first air intake port 211 flows through in the first space IS1 as the first airflow AF1. In addition, external air taken in through the second air intake port 212 flows through as the second airflow AF2 in the second space IS2. In other words, the airflow AF includes the first airflow AF1 and the second airflow AF2. The first airflow AF1 is then configured to pass through the first space IS1. The second airflow AF2 is configured to pass through the second space IS2. With this configuration, the first airflow AF1 passing through the first space IS1 allows the battery 7 to be cooled more effectively and also improves operability at high output.

In addition, the filter mounting portion 211a of the first air intake port 211 is provided with a filter 8, and the filter 8 is arranged at the rear of the body portion 2 so as to cover the first air intake port 211. That is, the body portion 2 includes a filter 8 and is configured to direct the first airflow AF1 through the filter 8 to the first space IS1. In addition, the filter 8 includes a collection surface 81 for collecting objects to be collected in external air. The collection surface 81 is circular in plan view and is inclined upward at an angle from the front side to the rear side. That is, the filter 8 is configured to collect objects to be collected in the first airflow AF1. With this configuration, the battery 7 can be cooled while the filter 8 removes objects to be collected from external air.

In addition, the filter 8 is removable from the filter mounting portion 211a of the body portion 2. By removing the filter 8 from the body portion 2, the battery 7, which is attached inside the first space IS1, can be detached. In addition, by removing the filter 8 from the body portion 2, objects to be collected which is collected on the collection surface 81 of the filter 8 can be easily removed from the collection surface 81.

In addition, the filter 8 and the body portion 2 are preferably configured with a removable mechanism, such as a snap-fit mechanism, magnet mechanism, bayonet mechanism, screw fastener mechanism, friction fit mechanism, etc. Specifically, it is preferable that the filter 8 and the body portion 2 are configured to be removable, as a magnet mechanism, by means of magnets 82 disposed above and below the filter 8, and a magnet 211b disposed on the filter mounting portion 211a (above and below the first air intake port 211 of the body portion 2).

### Other

The blower 1 according to one embodiment may be implemented in the following configurations.

In one embodiment shown in FIG. 5, the battery 7 is disposed below the first space IS1, and the communication hole 51 is formed above the first space IS1, so that a space is provided between the battery 7 and the portion of the partition wall 5 that defines the communication hole 51, which is not limited to this configuration. For example, the battery 7 may be disposed above the first space IS1 and the communication hole 51 may be formed above the first space IS1. As shown in FIG. 6, the specific configuration is as follows. Above the first space IS1, a communication hole 51 is formed in the partition wall 5 to connect the first space IS1 with the second space IS2. In addition, the battery mounting portion 27, which has a communication hole 27a, is disposed above the first space IS1. Accordingly, the portion of the partition wall 5 that defines the communication hole 51 and the portion of the battery mounting portion 27 that defines the communication hole 27a are brought into contact with each other. Thus, the first space IS1 and the second space IS2 are connected through the communication hole 51 and the communication hole 27a. Further, when the battery 7 is mounted to the battery mounting portion 27, the battery 7 is disposed such that at least a portion thereof covers the communication hole 27a. That is, the battery 7 is disposed such that at least a part of it covers the communication hole 51 through the communication hole 27a. In other words, battery 7 is disposed to cover the communication hole 51. With this configuration, the airflow AF is directed directly to at least a portion of the battery 7 through the communication hole 51 of the partition wall 5, which allows the battery 7 to be cooled efficiently. As a result, the operability can be further improved at high output. The battery mounting portion 27 may be configured so that the battery 7 directly contacts the portion of the partition wall 5 defining the communication hole 51.

Further, the battery 7 may include a case 71, the case 71 having a first opening 711 and a second opening 712. As shown in FIG. 6, specifically, the battery 7 has a first opening 711 on the opposite side of the case 71 to the communication hole 51 and a second opening 712 on the same side of the case 71 when mounted in the battery mounting portion 27. The first opening 711 and the second opening 712 are connected through the air passage 713. That is, the air passage 713 opens at the first opening 711 on one end and opens at the second opening 712 on the other end. This configuration allows air taken in through the first opening 711 to be distributed through the air passage 713 toward the second opening 712. In other words, the first opening 711 is configured to allow air to flow into the interior of the case 71, and the second opening 712 is configured to communicate with the first opening 711 and to discharge air from an inside of the case 71.

The air passage 713 is disposed so as to cool the secondary batteries housed inside the battery 7. Specifically, the air passage 713 is disposed between a plurality of stored secondary batteries, between the case 71 and the secondary batteries, or in other similar positions. That is, air passage 713 is disposed near the secondary battery. The secondary battery is thus configured to be cooled by air circulating in the internal configuration of air passage 713. The second opening 712 is configured to be connected to the communication hole 51 and the connecting hole 27a when the battery 7 is attached to the battery mounting portion 27. That is, the battery 7 is positioned so that the communication hole 51 and the second opening 712 are connected. Thus, the second opening 712 is positioned facing the communication hole 51 with the battery 7 attached to the battery mounting portion 27. In other words, the communication hole 51 and the second opening 712 are disposed so as to face each other when the battery 7 is mounted in the blower 1. The second opening 712 and the communication hole 51 may not be connected, and a space may be provided between the second opening 712 and the communication hole 51.

Further, with the battery mounting portion 27 positioned on the top surface portion of the partition wall 5, the connection terminal 72 of the battery 7 is positioned above, on the same side as the communication hole 51 to the battery 7. That is, it is preferable that the battery mounting portion 27 is configured to be positioned at the same side as the communication hole 51 with respect to the battery 7 and is connected to the connection terminal 72, when the battery is attached to the battery mounting portion. With this configuration, since the communication hole 51 and the battery mounting portion 27 are located on the same side of the partition wall 5, the communication hole 51 of the partition wall 5 and the second opening 712 of the battery 7 are brought into communication. This allows the battery 7 to be cooled more efficiently because the airflow AF is directed directly to at least part of the battery 7. As a result, operability at high output can be further improved.

In one embodiment shown in FIG. 5, the case in which the communication hole 51 of the partition wall portion 5 is formed above the first space IS1 is described, but the invention is not limited to the case in which the communication hole 51 of the partition wall portion 5 is formed below, or above and below, the first space IS1. Specifically, as shown in FIG. 7, the communication holes 51 are formed above and below the first space IS1. The communication hole 51, positioned below the first space IS1, is connected to the communication hole 27a of the battery mounting portion 27. The communication holes 51 are thus configured to be connected to the first opening 711 and the second opening 712 of the battery 7 via the communication holes 27a when the battery 7 is attached to the battery mounting portion 27. With this configuration, an airflow AF is directed into the interior of the case 71 of the battery 7 through the communication hole 51 of the partition wall 5 to directly cool the secondary battery stored in the interior of the case 71. Therefore, the blower 1 in such a configuration can provide excellent operability at high output. In the embodiment shown in FIG. 5, an example is described in which the battery 7 is disposed along the lower side of the first space IS1 so as to provide a space between the battery 7 and the portion of the partition wall 5 that defines the communication hole 51, and the communication hole 51 is formed above the first space IS1. However, the invention is not limited to this configuration. For example, the battery 7 may be positioned below the first space IS1 along the top of the first space IS1. Specifically, as shown in FIG. 8, the battery mounting portion 27 is preferably configured such that the top surface portion of the battery 7 contacts the top surface portion of the partition wall 5 when the battery 7 is attached to the battery mounting

In one embodiment shown in FIG. 5, the case in which the communication hole 51 of the partition wall portion 5 is formed above the first space IS1 is described, but the invention is not limited to the case in which the communication hole 51 of the partition wall portion 5 is formed below, or above and below, the first space IS1. Specifically, as shown in FIG. 7, the communication holes 51 are formed above and below the first space IS1. The communication hole 51, positioned below the first space IS1, is connected to the communication hole 27a of the battery mounting portion 27. The communication holes 51 are thus configured to be connected to the first opening 711 and the second opening 712 of the battery 7 via the communication holes 27a when the battery 7 is attached to the battery mounting portion 27. With this configuration, an airflow AF is directed into the interior of the case 71 of the battery 7 through the communication hole 51 of the partition wall 5 to directly cool the secondary battery stored in the interior of the case 71. Therefore, the blower 1 in such a configuration can provide excellent operability at high output. In the embodiment shown in FIG. 5, an example is described in which the battery 7 is disposed along the lower side of the first space IS1 so as to provide a space between the battery 7 and the portion of the partition wall 5 that defines the communication hole 51, and the communication hole 51 is formed above the first space IS1. However, the invention is not limited to this configuration. For example, the battery 7 may be positioned below the first space IS1 along the top of the first space IS1. Specifically, as shown in FIG. 8, the battery mounting portion 27 is preferably configured such that the top surface portion of the battery 7 contacts the top surface portion of the partition wall 5 when the battery 7 is attached to the battery mounting portion 27. The surface on which the battery 7 is mounted in the battery mounting portion 27 is inclined so that the rear is positioned higher than the front. Due to the relationship between this inclination and the vertical thickness of the battery 7, the battery mounting portion 27 is configured such that the upper surface of the battery 7 contacts the inner upper surface of the partition wall 5 when the battery 7 is mounted. Further, in the battery 7, the second opening 712 is provided at the upper portion of the case 71, and the first opening 711 is provided on the rear side surface of the case 71 of the battery 7, such that air flows through the interior of the case 71 of the battery 7. The first and second openings 711 and 712 are configured to be connected to the communication hole 51 when the battery 7 is mounted in the battery mounting portion 27. With this configuration, the airflow AF taken in from the first intake port 211 can be introduced into the second space IS2 through the first opening 711 and the second opening 712 of the battery 7, and through the communication hole 51 of the partition wall 5. This allows the secondary battery stored inside the battery 7 to be cooled directly, thus enabling the battery 7 to be cooled efficiently. As a result, the operability can be further improved at high output.

In one embodiment described above, the case in which a detachable blower pipe 3 is attached to the jet port 22 of the body portion 2 is described as an example, but the disclosure is not limited thereto. For example, the body portion 2 and blower pipe 3 may be formed as one piece so that the blower pipe 3 cannot be detached from the body portion 2.

In one embodiment shown in FIG. 3, an example is described in which the first space IS1 is formed by the front-end portion of the partition wall 5 being closed in a cylindrical shape. However, the invention is not limited to this configuration. For example, the first space IS1 may be formed by the front-end portion of the partition wall 5 being covered by the rear-end surface of the coupling portion 45. Specifically, as shown in FIG. 9, the front-end portion of the partition wall 5 has an open cylindrical shape, and a spherical surface of the rear-end surface of the coupling portion 45 is preferably disposed along this cylindrical shape. In other words, the front side of the first space IS1 is preferably covered by a portion of the axial flow fan 40. With this configuration, the first space IS1 is formed by a part of the shaft portion 40 and the partition wall 5 of the axial flow fan 40. This allows the blower 1 to be made smaller and improves operability at high output.

In one embodiment shown in FIG. 2, an example is described in which the air intake port 21 is disposed in the rear wall portion of the body portion 2. However, the disclosure is not limited to this configuration. The air intake port 21 may also be disposed in the circumferential wall portion of the body portion 2, in addition to or instead of the rear wall portion of the body portion 2. Specifically, as shown in FIG. 10, the air intake port 21 may be disposed on the left and right sides of the rear side portion of the body portion 2. The air intake ports 21 may be positioned in the upper, lower, right, left, and a combination of these directions. In other words, the air intake port 21 may open in a rear wall portion and a circumferential wall portion of the body portion 2, and may open into at least one of the rear wall and circumferential direction wall of the body portion 2. With this configuration, the air intake ports 21 are disposed on the side and peripheral walls, which allows more external air to be drawn in and efficiently cool the battery 7. The result is excellent operability at high output.

In one embodiment described above, the case in which a detachable blower pipe 3 is attached to the jet port 22 of the body portion 2 is described as an example, but the disclosure is not limited thereto. For example, the body portion 2 and blower pipe 3 may be formed as one piece so that the blower pipe 3 cannot be detached from the body portion 2.

In addition, it may be provided in each of the following configurations.

1) A blower to be used by mounting a battery, comprising a body portion including: a jet port provided at a front side of the body portion; an airflow generation unit configured, by being supplied with electric power from the battery, to generate an airflow in an interior space of the body portion from a rear of the body portion toward the jet port; and a partition wall disposed to divide the interior space into a first space and a second space, wherein: the first space is configured to receive the battery, and the second space is positioned outside of the first space, and is configured to allow the airflow to pass therethrough.

With this configuration, the battery is placed in the first space, which is the internal space of the body unit, so that the battery can be cooled by the airflow generated by the airflow generation unit. As a result, the operability can be improved at high output.

(2) The blower according to (1), wherein: the partition wall portion includes a communication hole, and the communication hole is configured to connect the first space to the second space.

With this configuration, the first space and the second space are connected by the communication hole, which allows the battery to be further cooled by the airflow generated by the airflow generation unit. As a result, the operability can be improved at high output.

(3) The blower according to (2), wherein the battery is disposed to cover the communication hole.

With this configuration, the airflow is directed directly to at least a portion of the battery through the communication holes in the partition wall, which allows the battery to be cooled efficiently. As a result, the operability can be further improved at high output.

(4) The blower according to (2) or (3), wherein: the battery includes a case, including: a first opening configured to allow air to flow into the interior of the case, and a second opening connected to the first opening and configured to discharge air from an inside of the case, and the communication hole and the second opening are disposed so as to face each other when the battery is mounted in the blower.

With this configuration, the communication hole of the partition wall and the second opening of the battery are positioned opposite each other, which allows the battery to be cooled even more efficiently and further improves operability at high output.

(5) The blower according to any one of (2) to (4), wherein the communication hole is configured to be positioned above the battery when the blower is in use.

With this configuration, the position of the communication hole on the upper side of the battery when the blower is in use allows the air flow from below to above (upward airflow) caused by the heat generation of the battery to be directed to the communication hole. Therefore, the blower in such a configuration can provide excellent operability at high output.

(6) The blower according to (5), wherein: the battery includes a connection terminal, and the body portion further includes a battery mounting portion configured to: be electrically connected to the airflow generation unit and allow the battery to be removable, and be positioned opposite the communication hole with respect to the battery and be connected to the connection terminal, when the battery is attached to the battery mounting portion.

With this configuration, the position of the communication hole on the upper side of the battery when the blower is in use allows the air flow from below to above (upward airflow) caused by the heat generation of the battery to be directed to the communication hole. Therefore, the blower in such a configuration can provide excellent operability at high output.

(7) The blower according to any one of (2) to (4), wherein: the battery includes a connection terminal, the body portion further includes a battery mounting portion configured to: be electrically connected to the airflow generation unit and allow the battery to be removable from, and be positioned at the same side as the communication hole with respect to the battery and be connected to the connection terminal, when the battery is attached to the battery mounting portion.

With this configuration, in the partition wall, the communication hole and the battery mounting portion are positioned on the same side, which allows the airflow to be directed directly to at least a portion of the battery, thereby cooling the battery efficiently. As a result, the operability can be further improved at high output.

(8) The blower according to any one of (1) to (7), wherein: the body portion further includes an air intake port configured to: open in a rear wall portion of the body portion, and direct external air into the second space of the body portion.

With this configuration, the battery disposed in the first space is cooled through the partition wall and the airflow can be generated efficiently by the airflow generation unit, which can further improve the operability at high output.

(9) The blower according to any one of (1) to (8), wherein: the second space forms a space surrounding an entire circumference of the first space, and the body portion further includes an air intake port configured to: open in a rear wall portion of the body portion, and direct external air into the second space of the body portion.

With this configuration, the partition wall is arranged to demarcate the periphery of the first space, and external air is led into the second space, which allows for efficient cooling of the battery and further improves operability at high output.

(10) The blower according to any one of (1) to (9), wherein: the body portion further includes an air intake port configured to: open in a rear wall portion and a circumferential wall portion of the body portion, and direct external air into the second space of the body portion.

With this configuration, the air intake ports are disposed on the side and peripheral walls, which allows more external air to be drawn in and efficiently cool the battery. The result is excellent operability at high output.

(11) The blower according to any one of (1) to (10), wherein: the airflow includes: a first airflow passing through the first space, and a second airflow passing through the second space.

With this configuration, the first airflow passing through the first space allows the battery to be cooled more effectively and also improves operability at high output.

(12) The blower according to (11), wherein the body portion: further includes a filter, and is configured to direct the first airflow through the filter to the first space, the filter being configured to collect objects to be collected contained in the first airflow.

With this configuration, the battery can be cooled while the filter removes collect objects to be collected from external air.

(13) The blower according to any one of (1) to (12), wherein the airflow generation unit is disposed forward of the partition wall.

With this configuration, the battery can be efficiently cooled to improve operability at high output. In addition, the circumferential direction of the body portion can be designed to be smaller, which contributes to the downsizing of the blower.

(14) The blower according to any one of (1) to (13), wherein the airflow generation unit is configured to generate the airflow by an axial flow fan.

With this configuration, in a blower equipped with an axial flow fan, the battery can be efficiently cooled, which improves operability at high output.

(15) The blower according to (14), wherein the first space is configured such that a front side thereof is covered by a part of the axial flow fan.

With this configuration, the first space is formed by a shaft portion of the axial flow fan and a partition wall unit, which allows the blower to be compact while improving operability at high output. Of course, the present disclosure is not limited thereto.

Finally, various embodiments pertaining to the present invention have been described, which are presented as examples and are not intended to limit the scope of the invention. The novel embodiment can be implemented in various other forms, and various omissions, substitutions, and changes can be made without departing from the scope of the invention. Said embodiments and variations thereof are included in the scope and gist of the invention and its equivalents according to the claims.

What is claimed is:

1. A blower to be used by mounting a battery, comprising a body portion including:
a jet port provided at a front side of the body portion;
an airflow generation unit configured, by being supplied with electric power from the battery, to generate an airflow in an interior space of the body portion from a rear of the body portion toward the jet port; and
a partition wall disposed to divide the interior space into a first space and a second space, wherein:
the first space is configured to receive the battery, and
the second space is positioned outside of the first space, and is configured to allow the airflow to pass therethrough.

2. The blower according to claim 1, wherein:
the partition wall portion includes a communication hole, and
the communication hole is configured to connect the first space to the second space.

3. The blower according to claim 2, wherein the battery is disposed to cover the communication hole.

4. The blower according to claim 2, wherein:
the battery includes a case, including:
a first opening configured to allow air to flow into the interior of the case, and
a second opening connected to the first opening and configured to discharge air from an inside of the case, and the communication hole and the second opening are disposed so as to face each other when the battery is mounted in the blower.

5. The blower according to claim 2, wherein the communication hole is configured to be positioned above the battery when the blower is in use.

6. The blower according to claim 5, wherein:
the battery includes a connection terminal, and
the body portion further includes a battery mounting portion configured to:
be electrically connected to the airflow generation unit and allow the battery to be removable, and
be positioned opposite the communication hole with respect to the battery and be connected to the connection terminal, when the battery is attached to the battery mounting portion.

7. The blower according to claim 2, wherein:
the battery includes a connection terminal,
the body portion further includes a battery mounting portion configured to:
be electrically connected to the airflow generation unit and allow the battery to be removable from, and
be positioned at the same side as the communication hole with respect to the battery and be connected to the connection terminal, when the battery is attached to the battery mounting portion.

8. The blower according to claim 1, wherein:
the body portion further includes an air intake port configured to:
open in a rear wall portion of the body portion, and
direct external air into the second space of the body portion.

9. The blower according to claim 1, wherein:
the second space forms a space surrounding an entire circumference of the first space, and the body portion further includes an air intake port configured to:
open in a rear wall portion of the body portion, and
direct external air into the second space of the body portion.

10. The blower according to claim 1, wherein:
the body portion further includes an air intake port configured to:
open in a rear wall portion and a circumferential wall portion of the body portion, and direct external air into the second space of the body portion.

11. The blower according to claim 1, wherein:the airflow includes:
a first airflow passing through the first space, and
a second airflow passing through the second space.

12. The blower according to claim 11, wherein the body portion:
further includes a filter, and
is configured to direct the first airflow through the filter to the first space,
the filter being configured to collect objects to be collected contained in the first airflow.

13. The blower according to claim 1, wherein the airflow generation unit is disposed forward of the partition wall.

14. The blower according to claim 1, wherein the airflow generation unit is configured to generate the airflow by an axial flow fan.

15. The blower according to claim 14, wherein the first space is configured such that a front side thereof is covered by a part of the axial flow fan.
